(19) United States
(12) Patent Application Publication
(10) Pub. No.: US 2007/0224026 A1
(43) Pub. Date: Sep. 27, 2007

(54) TRANSFERRING SYSTEM

(75) Inventor: Min-gu Chang, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/610,204

(22) Filed: Dec. 13, 2006

(30) Foreign Application Priority Data
Mar. 22, 2006 (KR) 2006-26290

(51) Int. Cl. B65G 47/90

(52) U.S. Cl. 414/626

(57) ABSTRACT

A transferring system to travel along a rail to transfer and load and/or unload a workpiece include a transferring apparatus provided with a main body unit to travel along the rail, a sliding unit coupled to the main body unit to relatively move between a transferring position and a storing position with respect to the main body unit, and a hoist unit coupled to the sliding unit to move upward and downward the workpiece, and one or more buffering apparatus disposed beside a traveling path of the transferring apparatus to support the workpiece in the storing position, and provided with a supporting part to support the sliding unit when the sliding unit moves between the transferring position and the storing position.

### CROSS-REFERENCE TO RELATED APPLICATIONS

This application claims priority under 35 U.S.C. §119(a) from Korean Patent Application No.2006-0026290, filed on Mar. 22, 2006, in the Korean Intellectual Property Office, the disclosure of which is incorporated herein by reference in its entirety.

### BACKGROUND OF THE INVENTION

1. Field of the Invention

The present general inventive concept relates to a transferring system, and more particularly, to a transferring system to stably support a hoist unit or a workpiece in transferring the same between a transferring position and a storing position.

2. Description of the Related Art

Generally, a transferring system includes a transferring apparatus traveling along a path such as a rail to transfer a workpiece, a processing station provided on the path to process the workpiece, and a buffering apparatus disposed beside the path to temporarily store the workpiece.

The transferring apparatus may be classified into an automatic type, an overhead type, etc. Hereinafter, a transferring apparatus having an overhead type will be described by way of example. The overhead type transferring apparatus can transfer a reticle, an FOUP (front opening unified pod), etc. for manufacturing a semiconductor to the processing station or the buffering apparatus automatically. A transferring speed of the transferring apparatus is directly influenced by a transferring speed of a workpiece and a loading/unloading speed thereof, and may influence a whole manufacturing time.

Korean Patent First Publication No.2004-50704 published on Jun. 16, 2004 discloses a conventional overhead transferring vehicle system including a traveling path supported to a ceiling, a transferring vehicle supporting a workpiece to travel along the traveling path, a hoist provided inside the transferring vehicle to move upward/downward, and a warehouse and a buffer disposed beside the traveling path. Also, the overhead transferring vehicle system further includes a roller conveyer coupled to an inner side of the transferring vehicle to move between a moving loading position and a withdrawal position for supporting or releasing the workpiece. Also, the ceiling transferring vehicle system further includes a roller conveyer supporting the workpiece to the warehouse and the buffer to take in/out the workpiece.

For moving the workpiece from the transferring vehicle to the warehouse or the buffer, at first, the roller conveyer of the transferring vehicle is positioned to the moving loading position. Then, the respective roller conveyers are disposed to have the same level, and the roller conveyer of the warehouse or the buffer operates. Then, the workpiece is moved from the roller conveyer of the transferring vehicle to the roller conveyer of the warehouse or the buffer.

However, in the conventional overhead transferring vehicle system, the workpiece may be damaged by a shock in movement between the transferring vehicle and the warehouse or the buffer. Also, when a direction of the workpiece deviates, loading/unloading thereof is apt to fail. Also, because the roller conveyer of the transferring vehicle moves between the moving loading position and the withdrawal position, the configuration and the control thereof are complicated, and a transferring time increases. Further, it will be convenient if the buffering apparatus is placed at lateral opposite sides of the transferring path of the transferring vehicle.

### SUMMARY OF THE INVENTION

The present general inventive concept provides a transferring system to stably support a hoist unit or a workpiece in transferring the same between a transferring position and a storing position, to thereby rapidly load and/or unload the workpiece.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a transferring system to travel along a rail to transfer and load and/or unload a workpiece, the transferring system including a transferring apparatus provided with a main body unit to travel along the rail, a sliding unit coupled to the main body unit to relatively move between a transferring position and a storing position with respect to the main body unit, and a hoist unit coupled to the sliding unit to move upward and downward the workpiece, and one or more buffering apparatus disposed beside a traveling path of the transferring apparatus to support the workpiece in the storing position, and provided with a supporting part to support the sliding unit when the sliding unit moves between the transferring position and the storing position.

The sliding unit may include a sliding unit main body coupled to a lower part of the main body unit, a plurality of sliding brackets provided to a first side of the sliding unit main body to be arranged along an up and/or down direction of the hoist unit, and a sliding driving part to supply a driving force so that the sliding brackets move between the transferring position and the storing position.

The sliding driving part may include a driving motor coupled to a second side of the sliding unit main body, a driving pinion connected to the driving motor to rotate, and a driving rack coupled to one of the sliding brackets to be engaged with the driving pinion.

The sliding unit may include a sliding guiding part interposed between the respective sliding brackets to guide one of the sliding brackets with respect to another of the sliding brackets, a relative moving part to relatively move at least one of the sliding brackets when the sliding driving part moves another of the sliding brackets, and a moving supporting part coupled to the sliding unit main body to movably support the sliding brackets.

The sliding guiding part may include an LM guide.

The sliding brackets may include a planar first sliding bracket coupled to an upper part of the sliding unit main body, a planar second sliding bracket distanced below the first sliding bracket to be coupled to the driving rack, a planar third sliding bracket distanced below the second sliding bracket, and a planar fourth sliding bracket distanced below the third sliding bracket to be coupled to the hoist unit.

The relative moving part may include a first relative moving member to transmit a relative moving of the second sliding bracket driven by the sliding driving part with respect to the first sliding bracket to a relative moving of the third sliding bracket with respect to the second sliding bracket, and a second relative moving member to transmit a relative moving of the third sliding bracket with respect to the second sliding bracket to a relative moving of the fourth sliding bracket with respect to the third sliding bracket.

The first relative moving member may include a first relative moving rack coupled to a lower side of the first sliding bracket to parallel the sliding guiding part, a first relative moving shaft rotatably coupled to the second sliding bracket, a first relative moving pinion provided to a first side of the first relative moving shaft to be rotatably engaged with the first relative moving rack according to the relative moving of the second sliding bracket, a second relative moving pinion provided to a second side of the first relative moving shaft to rotate according to rotating of the first relative moving pinion, and a second relative moving rack coupled to an upper side of the third sliding bracket, disposed parallel to the sliding guiding part, and engaged with the second relative moving pinion to relatively move the third sliding bracket with respect to the second sliding bracket.

The second relative moving member may include a third relative moving rack coupled to a lower side of the second sliding bracket to parallel the sliding guiding part, a second relative moving shaft rotatably coupled to the third sliding bracket, a third relative moving pinion provided to a first side of the second relative moving shaft to be rotatably engaged with the third relative moving rack according to the relative moving of the third sliding bracket, a fourth relative moving pinion provided to a second side of the second relative moving shaft to rotate according to rotating of the third relative moving pinion, and a fourth relative moving rack coupled to an upper side of the fourth sliding bracket, disposed parallel to the sliding guiding part, and engaged with the fourth relative moving pinion to relatively move the fourth sliding bracket with respect to the third sliding bracket.

The moving supporting part may include a roller coupled to the sliding unit main body to movably support the sliding brackets.

The buffering apparatus may include a workpiece supporting plate to support the workpiece, a plurality of buffer supporting members to extend in an up and/or down direction of the hoist unit, and supported to an installation surface to be coupled to the workpiece supporting plate, and a planar buffer supporting bracket coupled to the buffer supporting members to be coupled to the supporting part.

The supporting part may include a roller movably supporting the sliding brackets.

The buffering apparatus may be disposed in opposite sides with respect to the traveling direction of the transferring apparatus to be distanced from the transferring apparatus.

The foregoing and/or other aspects of the present general inventive concept may be achieved by providing a transferring system to transfer a workpiece, the transferring system including a transferring apparatus having a main body unit to travel along a traveling path, a sliding unit coupled to the main body and having first and second brackets, a sliding driving part to move the first bracket by a first distance with respect to the main body unit, and a relative moving part to move the second bracket with respect to the first bracket by a second distance according to a movement of the first bracket, and a hoist unit coupled to the second bracket to carry a workpiece.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a plan view schematically illustrating a transferring system according to an embodiment of the present general inventive concept;

FIG. 2 is a sectional view taken along line II-II in FIG. 1;

FIG. 3 is a sectional view taken along line III-III in FIG. 1;

FIG. 4 is a sectional view of a sliding unit of the transferring system in FIG. 1;

FIG. 5A is a perspective view illustrating an operating state of a first relative moving member of the transferring system in FIG. 1;

FIG. 5B is a perspective view illustrating an operating state of a second relative moving member of the transferring system in FIG. 1; and

FIGS. 6A to 6D are side sectional views illustrating operating processes of the transferring system in FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. Hereinafter, among various transferring apparatuses, an overhead type transferring apparatus to transfer a reticle, FOUP, etc., which is used in a semiconductor process will be exemplarily described.

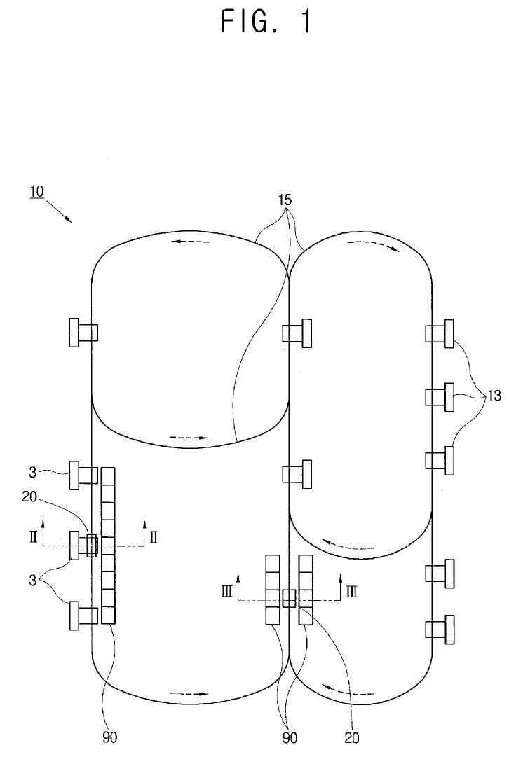

As illustrated in FIGS. 1 to 4, a transferring system 10 according to an embodiment of the present general inventive concept includes a rail 15 supported by or disposed on an installation surface such as a ceiling, a transferring apparatus 20 provided with a main body unit 21 to travel along the rail 15, a sliding unit 30 coupled to the main body unit 21 to relatively move between a transferring position and a storing position, and a hoist unit 80 coupled to the sliding unit 30 to move upward and downward a workpiece 13, and a buffering apparatus 90 disposed beside a traveling direction of the transferring apparatus 20 to support the workpiece 13 in the storing position, and provided with at least one supporting part 91 to support the sliding unit 30 when the sliding unit 30 moves between the transferring position and the storing position. Also, referring to FIG. 1, the transferring system 10 loads and/or unloads the workpiece 13 to and/or from a processing station 3 so that the processing station 3 performs a predetermined process. At this time, the transferring system 10 may temporarily store the workpiece 13 to the buffering apparatus 90.

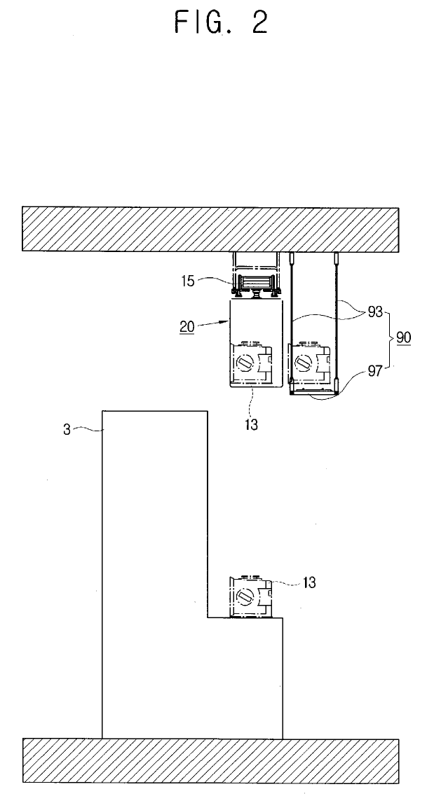

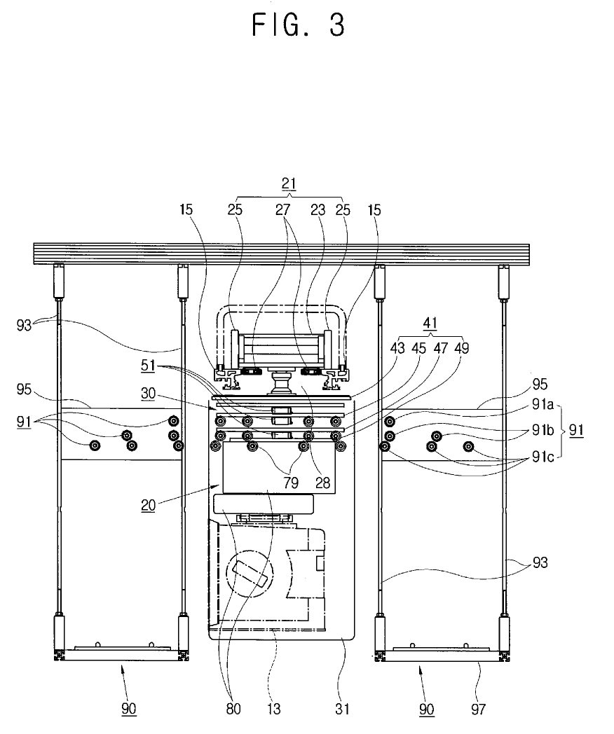

Referring to FIGS. 2 and 3, the workpiece 13 is supported by a lower part of the hoist unit 80 to be moved, and is loaded and/or unloaded to and/or from the processing station 3 or the buffering apparatus 90. The workpiece 13 includes a reticle and a FOUP (front opening unified pod) used for manufacturing a semiconductor, etc. The workpiece 13 is supported by the hoist unit 80 inside the sliding unit 30 to be moved between the transferring position in which the workpiece 13 is transferred along the rail 15 and the storing position in which the workpiece 13 is supported by a workpiece supporting plate 97 of the buffering apparatus 90 to be temporarily stored.

Referring to FIG. 3, the rail 15 is supported by or coupled to an installation surface, such as a ceiling, to be in contact with a traveling wheel 25 and a guiding wheel 27 of the transferring apparatus 20 so that the transferring apparatus 20 travels. Referring to FIG. 1, the rail 15 has a plurality of branches having various directions.

The transferring apparatus 20 includes the main body unit 21 to travel along the rail 15, the sliding unit 30 coupled to the main body unit 21 to relatively move between the transferring position and the storing position, and the hoist unit 80 coupled to the sliding unit 30 to move the workpiece 13 upward and downward or left and right. The transferring apparatus 20 may be provided in plural as necessary, and can be controlled to sequentially transfer the workpiece 13 without interfering one another.

Referring to FIGS. 2 and 3, the main body unit 21 includes a unit main body 23, the traveling wheel 25 coupled to the unit main body 23 to be in contact with an upper part of the rail 15 so that the transferring apparatus 20 travels, and the guiding wheel 27 to contact an inner side of the rail 15 so that the transferring apparatus 20 stably travels along a travel path of the rail 15 without being deviated from the rail 15. A lower part 28 of the main body unit 21 is coupled to the sliding unit 30. The main body unit 21 may include a driving part (not shown) to supply a driving force to the traveling wheel 25.

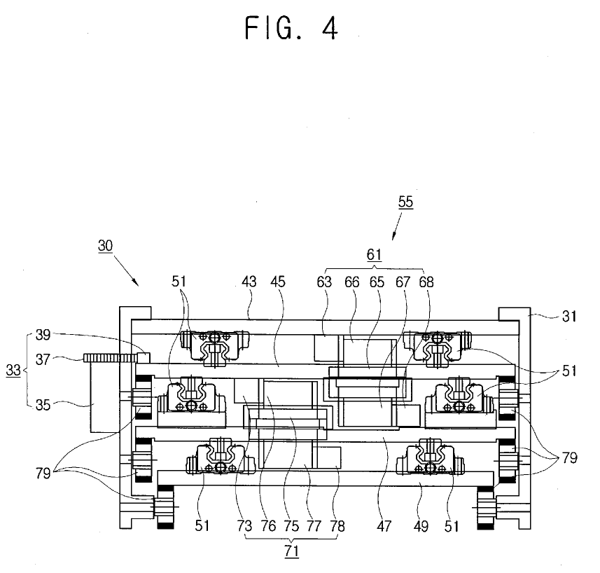

Referring to FIGS. 3 and 4, the sliding unit 30 is coupled to the main body unit 21 to relatively move between the transferring position and the storing position with respect to the main body unit 21. The sliding unit 30 includes a sliding unit main body 31 coupled to the lower part 28 of the main body unit 21, a plurality of sliding brackets 41(43, 45, 47, and 49) provided to a side of the sliding unit main body 31 to be arranged along an up/down direction of the hoist unit 80, and a sliding driving part 33 to supply a driving force so that the sliding brackets 41 move between the transferring position and the storing position. Also, the sliding unit 30 includes at least one sliding guiding part 51 interposed between the sliding brackets 41 to guide one of the sliding brackets 41 with respect to another of the sliding brackets 41, a relative moving part 55 to relatively move at least one of the sliding brackets 41 sequentially if the sliding driving part 33 moves another of the sliding brackets 41, and a moving supporting part 79 coupled to the sliding unit main body 31 to movably support the sliding brackets 41. Accordingly, the workpiece 13 supported to the hoist unit 80 can be stably and rapidly moved to the buffering apparatus 90 by the sliding unit 30.

Referring to FIG. 4, the sliding unit main body 31 is formed in a bent planar shape, and is opened in a moving direction of the sliding brackets 41. The moving supporting part 79 is coupled to the sliding unit main body 31 to slidably support the sliding brackets 41 to move between the transferring position and the storing position. A driving motor 35 is coupled to a side of the sliding unit main body 31. A first sliding bracket 43 is coupled to an upper side of the sliding unit main body 31.

Referring to FIG. 4, the sliding driving part 33 includes the driving motor 35, a driving pinion 37 connected to the driving motor 35, and a driving rack 39 coupled to a second sliding bracket 45 to interlock with the driving pinion 37. Here, the driving motor 35 may include a servomotor, and control a moving distance of the sliding brackets 41 by controlling the servomotor. Also, the driving motor 35 may rotate in clockwise and counterclockwise directions to move the sliding brackets 41 to the buffering apparatuses 90 disposed in the opposite sides with respect to the traveling direction of the transferring apparatus 20. Thus, the second sliding bracket 45 is moved by the driving motor 35, and the second sliding bracket 45 relatively moves a third sliding bracket 47 and a fourth sliding bracket 49.

Referring to FIGS. 3 to 5B, the sliding brackets 41 are provided to a side of the sliding unit main body 31 in plural to be arranged in the up/down direction of the hoist unit 80. The sliding brackets 41 include the first sliding bracket 43 formed in a planar shape to be coupled to an upper part of the sliding unit main body 31, the second sliding bracket 43 distanced below the first sliding bracket 43 and formed in a planar shape to be coupled to the driving rack 39, the third sliding bracket 47 distanced below the second sliding bracket 45 to be formed in a planar shape, and the fourth sliding bracket 49 distanced below the third sliding bracket 47 and to be formed in a planar shape to be coupled to the hoist unit 80. The second sliding bracket 45, the third sliding bracket 47 and the fourth sliding bracket 49 are slidably supported by the moving supporting part 79. Here, the sliding brackets 41 may alternatively include more than five sliding brackets or less than three sliding brackets in consideration of a size of the workpiece 13, a capacity of the buffering apparatus 90, etc. The sliding guiding part 51 is coupled between the sliding brackets 41 to include an LM (linear motion) guide. Also, the relative moving part 55 is provided to penetrate through the sliding brackets 41 or to be coupled thereto. Thus, the sliding brackets 41 can slide to arrange one another so that the hoist unit 80 moves between the transferring position and the storing position, and accordingly, the workpiece 13 supported to the hoist unit 80 can be moved stably and rapidly.

Referring to FIGS. 3 and 4, at least one sliding guiding part 51 is interposed between the respective sliding brackets 41 so that one of the sliding brackets 41 is guided with respect to another one of the sliding brackets 41. The sliding guiding part 51 includes the LM guide. The sliding guiding part 51 may be provided in opposite sides of the sliding brackets 41 to stably guide the sliding brackets 41. The sliding guiding part 51 may be provided as various known means such as a roller and a roller guide which can guide the sliding brackets 41 to move between the transferring position and the storing position. Thus, the sliding brackets 41 can stably relatively move.

Referring to FIGS. 4 to 6D, if the sliding driving part 33 drives the second sliding bracket 45, the relative moving part 55 allows the third sliding bracket 47 and the fourth sliding bracket 49 to relatively move sequentially. The relative moving part 55 includes a first relative moving member 61 to transmit a relative moving of the second sliding bracket 45 with respect to the first sliding bracket 43 to a relative moving of the third sliding bracket 47 with respect to the second sliding bracket 45, and a second relative moving member 71 to transmit a relative moving of the third sliding bracket 47 with respect to the second sliding bracket 45 to a relative moving of the fourth sliding bracket 49 with respect to the third sliding bracket 47. The relative moving part 55 has a rack and pinion configuration to minimize an external force to move the sliding brackets 41 when the transferring apparatus 20 travels. Thus, the sliding brackets can stably and rapidly move between the transferring position and the storing position.

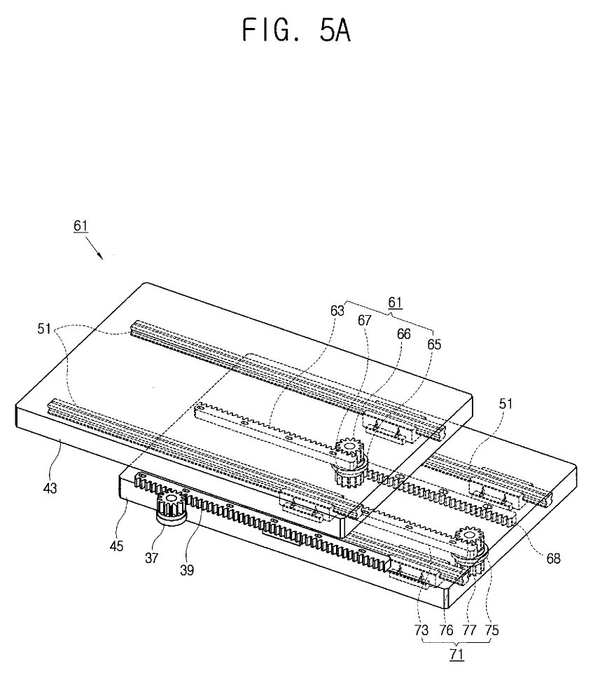

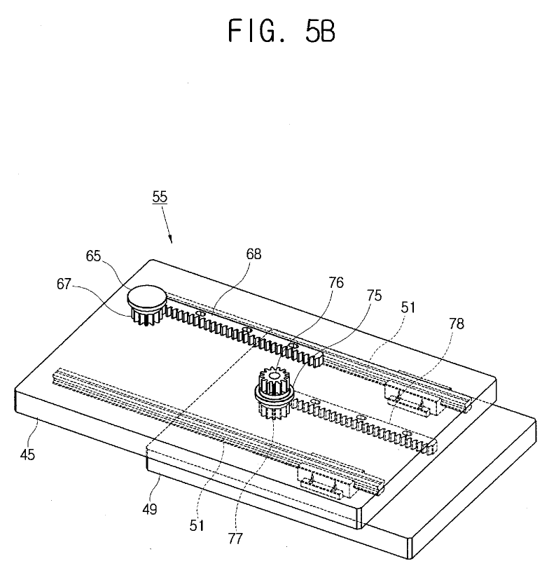

Referring to FIGS. 4 to 5B, the first relative moving member 61 includes a first relative moving rack 63 coupled to a lower side of the first sliding bracket 43 and disposed parallel to the sliding guiding part 51, a first relative moving shaft 65 rotatably coupled to the second sliding bracket 45 by a bearing or the like, a first relative moving pinion 66 provided to a first side of the first relative moving shaft 65 to rotatably interlock with the first relative moving rack 63 according to moving of the second sliding bracket 45, a second relative moving pinion 67 provided to a second side of the first relative moving shaft 65 to rotate according to rotating of the first relative moving pinion 66, and a second relative moving rack 68 coupled to an upper side of the third sliding bracket 47 and disposed parallel to the sliding guiding part 51 and interlocking with the second relative moving pinion 67 to relatively move the third sliding bracket 47 with respect to the second sliding bracket 45. Here, the first relative moving pinion 66 and the second relative moving pinion 67 have the same pitch circle diameter, a module, etc., and may have a different size thereof.

Accordingly, referring to FIG. 5A, if the driving pinion 37 is rotated by the driving motor 35, the driving rack 39 coupled to the sliding bracket 45 and engaged with the driving pinion 37 moves with respect to the first sliding bracket 43 or the sliding unit main body 31. Thus, the second sliding bracket 45 coupled with the driving rack 39 slidingly moves from the transferring position toward the storing position with being supported by the moving supporting part 79 and being guided by the sliding guiding part 51. If the second sliding bracket 45 moves, the first relative moving rack 63 coupled to the lower side of the first sliding bracket 43 is engaged with the first relative moving pinion 66 coupled to the second sliding bracket 45, and accordingly, the second relative moving pinion 67 coupled to the second sliding bracket 45 rotates. If the second relative moving pinion 67 rotates, the second relative moving rack 68 engaged with the second relative moving pinion 67 and coupled to the third sliding bracket 47 moves toward the storing position. Thus, the third sliding bracket 47 coupled with the second relative moving rack 68 can move toward the storing position. For example, if the second sliding bracket 45 moves 100 mm with respect to the first sliding bracket 43 from the transferring position toward the storing position, the third sliding bracket 47 moves 100 mm with respect to the second sliding bracket 45 toward the storing position, and accordingly, the third sliding bracket 47 can move 200 mm with respect to the first sliding bracket 43 from the transferring position toward the storing position. These relative moving processes are simultaneously accomplished.

Referring to FIGS. 4 to 5B, the second relative moving member 71 includes a third relative moving rack 73 coupled to a lower side of the second sliding bracket 45 to parallel the sliding guiding part 51, a second relative moving shaft 75 rotatably coupled to the third sliding bracket 47 by a bearing or the like, a third relative moving pinion 76 provided to a first side of the second relative moving shaft 75 to be rotatably engaged with the third relative moving rack 73 according to moving of the third sliding bracket 47, a fourth relative moving pinion 77 provided to a second side of the second relative moving shaft 75 to rotate according to rotating of the third relative moving pinion 76, and a fourth relative moving rack 78 coupled to an upper side of the fourth sliding bracket 49 and disposed parallel to the sliding guiding part 51 and engaged with the fourth relative moving pinion 77 to relatively move the fourth sliding bracket 49 with respect to the third sliding bracket 47. Here, the third relative moving pinion 76 and the fourth relative moving pinion 77 have the same pitch circle diameter, a module, etc., and may have a different size thereof.

Accordingly, referring to FIG. 5B, if the second sliding bracket 45 moves, the third sliding bracket 47 moves from the transferring position toward the storing position by the first relative moving member 61. Simultaneously, if the second sliding bracket 45 moves, the third relative moving rack 73 coupled to the lower side of the second sliding bracket 45 is engaged with the third relative moving pinion 76 coupled to the third sliding bracket 47, and accordingly, the third relative moving pinion 76 rotates. If the third relative moving pinion 76 rotates, the fourth relative moving pinion 77 rotates, and the fourth relative moving rack 78 engaged with the fourth relative moving pinion 77 and coupled to the fourth sliding bracket 49 moves toward the storing position. Thus, the fourth sliding bracket 49 coupled with the fourth relative moving rack 78 can move toward the storing position. For example, if the second sliding bracket 45 moves 100mm with respect to the first sliding bracket 43 from the transferring position toward the storing position, the third sliding bracket 47 moves 100 mm with respect to the second sliding bracket 45 toward the storing position, and accordingly, moves 200 mm with respect to the first sliding bracket 43 from the transferring position toward the storing position. Also, the fourth sliding bracket 49 moves 100 mm with respect to the third sliding bracket 47 toward the storing position, and moves 200 mm with respect to the second sliding bracket 45 toward the storing position, and accordingly, moves 300 mm with respect to the first sliding bracket 43 toward the storing position. These relative moving processes are simultaneously accomplished by driving of the driving motor 35. If the fourth sliding bracket 49 reaches the storing position of the buffering apparatus 90, a control part (not shown) may control the driving motor 35 to stop. The sliding brackets 41 move while being supported by the moving supporting part 79 coupled to the sliding unit main body 31 and the supporting part 91 coupled to a buffer supporting bracket 95 (FIG. 3) and being slidingly guided by the sliding guiding part 51.

Accordingly, the hoist unit 80 can stably and rapidly move from the transferring position to the storing position by the sliding brackets 41.

Referring to FIGS. 3 and 4, the moving supporting part 79 is coupled to the sliding unit main body 31, and slidingly supports the second sliding bracket 45, the third sliding bracket 47 and the fourth sliding bracket 49. The moving supporting part 79 includes a cylindrical roller having a bearing, or may include other known configurations. The moving supporting part 79 may be respectively coupled to the second sliding bracket 45, the third sliding bracket 47 and the fourth sliding bracket 49 as necessary. Thus, the sliding brackets 41 can be stably supported to move between the transferring position and the storing position.

Referring to FIG. 3, the hoist unit 80 is coupled to a lower side of the sliding unit 30 to move upward/downward the workpiece 13. The hoist unit 80 may be controlled to rotate by a predetermined angle about an axis having the up/down direction thereof. The hoist unit 80 may include a clamp (not shown) grasping the workpiece 13.

Referring to FIGS. 2 and 3, at least one buffering apparatus 90 is supported by an installation surface such as a ceiling in opposite sides with respect to the traveling direction of the transferring apparatus 20 to support the workpiece 13 in the storing position. The buffering apparatus 90 includes the supporting part 91, the workpiece supporting plate 97, a plurality of buffer supporting members 93 formed in a circular pole type elongated in the up/down direction of the hoist unit 80 to be supported to the installation surface and to be coupled to the workpiece supporting plate 97, and the buffer supporting bracket 95 formed in planar shape to be coupled to the buffer supporting members 93 and provided in the opposite sides with respect to a moving direction of the sliding unit 30 to support the supporting part 91.

The buffering apparatus 90 may be distanced from the transferring apparatus 20 in opposite sides with respect to the traveling direction thereof. Thus, the transferring system 10 can enhance the efficiency of space utilization and create various transferring paths.

The supporting part 91 includes a plurality of first supporting members 91a to support the second sliding bracket 45, a plurality of second supporting members 91b to support the third sliding bracket 47, and a plurality of third supporting members 91c to support the fourth sliding bracket 49. Thus, in moving between the transferring position and the storing position, the sliding unit 30 can move stably and rapidly while being supported by the supporting part 91.

Here, the transferring system 10 may include a control part (not shown) to control the transferring apparatus 20 to transfer the workpiece to a predetermined position, to control the sliding unit 30 to move between the transferring position and the storing position, or to control the hoist unit 80 to load/unload the workpiece 13 to/from the buffering apparatus 90 or the processing station 3.

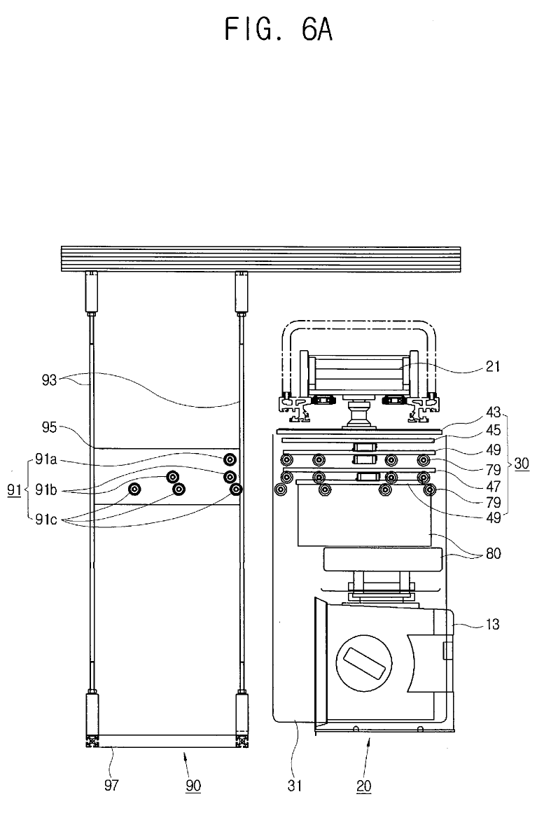

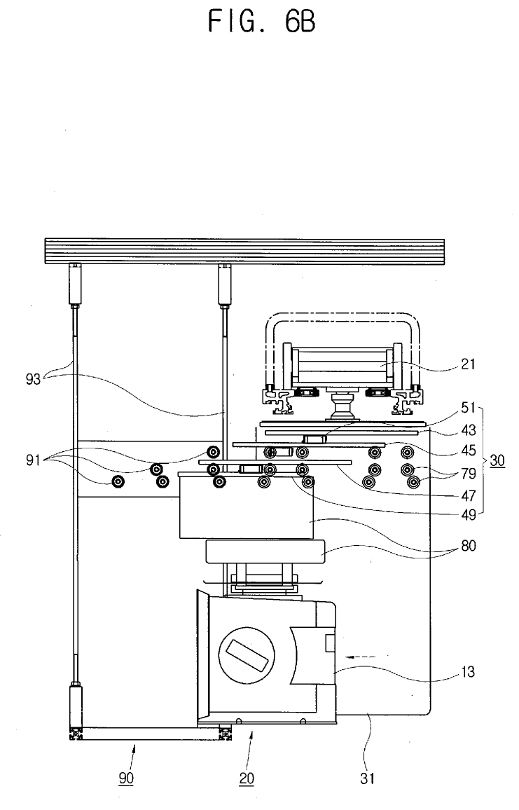

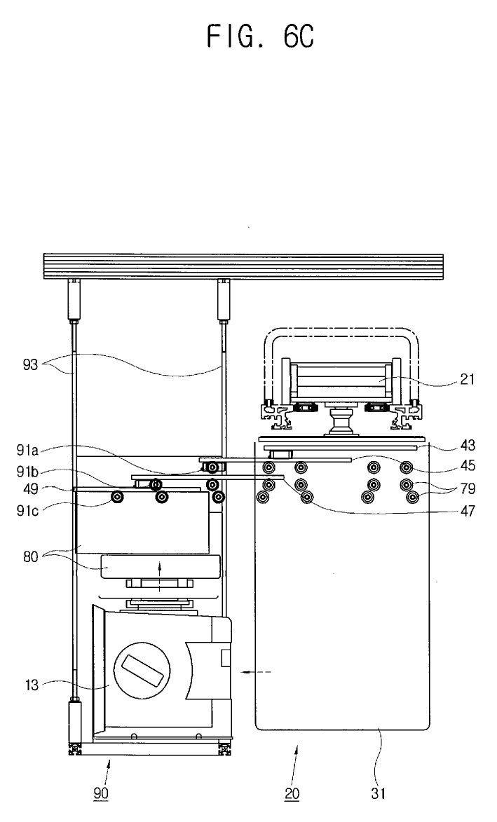

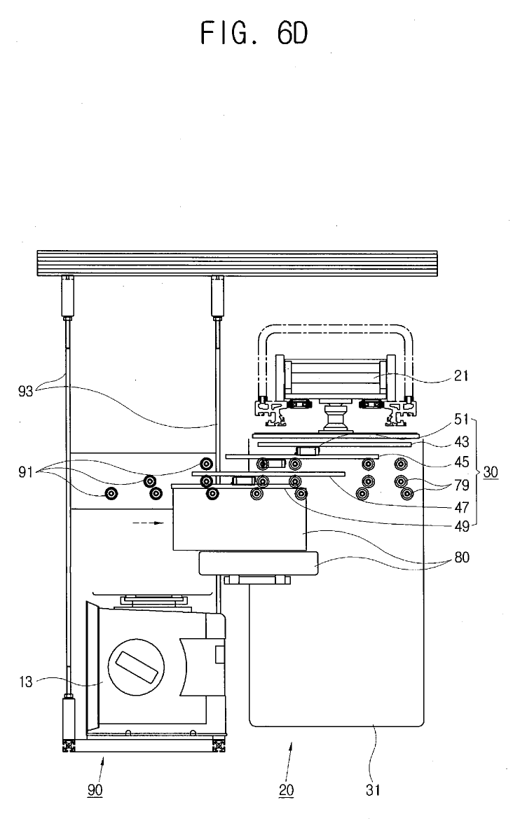

Hereinafter, a moving process of the transferring system 10 will be described by referring to FIGS. 5A to 6D.

At first, the transferring system 10 is supplied with power, and the transferring apparatus 20 travels to a predetermined position along the rail 15. The transferring apparatus 20 reaches the position and stops.

Referring to FIG. 6A, if the driving motor 35 of the sliding driving part 33 drives, the second sliding bracket 45 moves from the transferring position toward the storing position. Then, the third sliding bracket 47 and the fourth sliding bracket 49 simultaneously relatively move toward the storing position by the relative moving part 55 to form a stair shape. Thus, the hoist unit 80 coupled to the lower side of the fourth sliding bracket 49 to support the workpiece 13 can move from the transferring position to the storing position of the buffering apparatus 90. At this time, the sliding brackets 41 are supported by the moving supporting part 79 and the supporting part 91, and are guided by the sliding guiding part 51 interposed between the respective slide brackets 41.

Referring to FIG. 6B, if the hoist unit 80 reaches the storing position, the driving motor 35 of the sliding driving part 33 stops rotating.

Referring to FIG. 6C, the hoist unit 80 moves downward to seat the workpiece 13 on the workpiece supporting plate 97 of the buffering apparatus 90, and releases the workpiece 13, and then moves upward.

Referring to FIG. 6D, the driving motor 35 drives so that the sliding brackets 41 move from the storing position to the transferring position. At this time, the driving motor 35 may rotate in the opposite direction to a direction in which the driving motor 35 drives so that the sliding brackets 41 move from the transferring position to the storing position.

Also, in the case that the buffering apparatus 90 is disposed in opposite sides with respect to the traveling direction, the transferring system 10 operates with the same process, and therefore the repetitive descriptions will be avoided.

Accordingly, the hoist unit 80 can be stably supported by the sliding brackets 41 in moving between the transferring position and the storing position, to thereby rapidly load/unload the workpiece 13. Also, the transferring system 10 comprises the buffering apparatus 90 disposed in opposite sides with respect to the traveling direction of the transferring apparatus 20, thereby enhancing the efficiency of space utilization and creating various transferring paths.

As describe above, a transferring system according to the present invention can allow a hoist unit to be stably supported by a sliding bracket in moving between a transferring position and a storing position, to thereby rapidly load/unload a workpiece.

Also, a transferring system according to the present invention comprises a buffering apparatus disposed in opposite sides with respect to a traveling direction of a transferring apparatus, thereby enhancing the efficiency of space utilization and creating various transferring paths.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A transferring system to travel along a rail to transfer and load and/or unload a workpiece, comprising:
a transferring apparatus having a main body unit to travel along the rail, a sliding unit coupled to the main body unit to relatively move between a transferring position and a storing position with respect to the main body unit, and a hoist unit coupled to the sliding unit to move upward and downward the workpiece; and
one or more buffering apparatus disposed beside a traveling path of the transferring apparatus to support the workpiece in the storing position, and having a supporting part to support the sliding unit when the sliding unit moves between the transferring position and the storing position.

2. The transferring system according to claim 1, wherein the sliding unit comprises:
a sliding unit main body coupled to a first portion of the main body unit;
a plurality of sliding brackets provided to a first side of the sliding unit main body to be arranged along an up and/or down direction of the hoist unit; and
a sliding driving part to supply a driving force so that the sliding brackets move between the transferring position and the storing position.

3. The transferring system according to claim 2, wherein the sliding unit comprises:
a sliding guiding part interposed between the respective sliding brackets to guide the sliding brackets with respect to each other;
a relative moving part to relatively move at least one of the sliding brackets when the sliding driving part moves the other one of the sliding brackets; and
a moving supporting part coupled to the sliding unit main body to movably support the sliding brackets.

4. The transferring system according to claim 3, wherein the sliding brackets comprises:
a planar first sliding bracket coupled to an upper part of the sliding unit main body;
a planar second sliding bracket distanced below the first sliding bracket to be coupled to the driving rack;
a planar third sliding bracket distanced below the second sliding bracket; and
a planar fourth sliding bracket distanced below the third sliding bracket to be coupled to the hoist unit.

5. The transferring system according to claim 4, wherein the sliding guiding part comprises an LM guide.

6. The transferring system according to claim 5, wherein the relative moving part comprises:
a first relative moving member to transmit a relative moving of the second sliding bracket driven by the sliding driving part with respect to the first sliding bracket to a relative moving of the third sliding bracket with respect to the second sliding bracket; and
a second relative moving member to transmit a relative moving of the third sliding bracket with respect to the second sliding bracket to a relative moving of the fourth sliding bracket with respect to the third sliding bracket.

7. The transferring system according to claim 6, wherein the first relative moving member comprises:
a first relative moving rack coupled to a lower side of the first sliding bracket and disposed parallel to the sliding guiding part;
a first relative moving shaft rotatably coupled to the second sliding bracket;
a first relative moving pinion provided to a first side of the first relative moving shaft to be rotatably engaged with the first relative moving rack according to the relative moving of the second sliding bracket;
a second relative moving pinion provided to a second side of the first relative moving shaft to rotate according to rotating of the first relative moving pinion; and
a second relative moving rack coupled to an upper side of the third sliding bracket to parallel the sliding guiding part, and engaged with the second relative moving pinion to relatively move the third sliding bracket with respect to the second sliding bracket.

8. The transferring system according to claim 6, wherein the second relative moving member comprises:
a third relative moving rack coupled to a lower side of the second sliding bracket to parallel the sliding guiding part;
a second relative moving shaft rotatably coupled to the third sliding bracket;
a third relative moving pinion provided to a first side of the second relative moving shaft to be rotatably engaged with the third relative moving rack according to the relative moving of the third sliding bracket;
a fourth relative moving pinion provided to a second side of the second relative moving shaft to rotate according to rotating of the third relative moving pinion; and
a fourth relative moving rack coupled to an upper side of the fourth sliding bracket and disposed parallel to the sliding guiding part, and engaged with the fourth relative moving pinion to relatively move the fourth sliding bracket with respect to the third sliding bracket.

9. The transferring system according to claim 3, wherein the moving supporting part comprises a roller coupled to the sliding unit main body to movably support the sliding brackets.

10. The transferring system according to claim 2, wherein the sliding driving part comprises:
a driving motor coupled to a second side of the sliding unit main body;
a driving pinion connected to the driving motor to rotate; and
a driving rack coupled to one of the sliding brackets to be engaged with the driving pinion.

11. The transferring system according to claim 10, wherein the sliding unit comprises:
a sliding guiding part interposed between the respective sliding brackets to guide the sliding brackets with respect to each other;
a relative moving part to relatively move at least one of the sliding brackets when the sliding driving part moves the other one of the sliding brackets, and
a moving supporting part coupled to the sliding unit main body to movably support the sliding brackets.

12. The transferring system according to claim 11, wherein the sliding guiding part comprises an LM guide.

13. The transferring system according to claim 11, wherein the sliding brackets comprises:
a planar first sliding bracket coupled to an upper part of the sliding unit main body;
a planar second sliding bracket distanced below the first sliding bracket to be coupled to the driving rack;
a planar third sliding bracket distanced below the second sliding bracket; and
a planar fourth sliding bracket distanced below the third sliding bracket to be coupled to the hoist unit.

14. The transferring system according to claim 12, wherein the relative moving part comprises:
a first relative moving member to transmit a relative moving of the second sliding bracket driven by the sliding driving part with respect to the first sliding bracket to a relative moving of the third sliding bracket with respect to the second sliding bracket; and
a second relative moving member to transmit a relative moving of the third sliding bracket with respect to the second sliding bracket to a relative moving of the fourth sliding bracket with respect to the third sliding bracket.

15. The transferring system according to claim 14, wherein the first relative moving member comprises:
a first relative moving rack coupled to a lower side of the first sliding bracket and disposed parallel the sliding guiding part;
a first relative moving shaft rotatably coupled to the second sliding bracket;
a first relative moving pinion provided to a first side of the first relative moving shaft to be rotatably engaged with the first relative moving rack according to the relative moving of the second sliding bracket;
a second relative moving pinion provided to a second side of the first relative moving shaft to rotate according to rotating of the first relative moving pinion; and
a second relative moving rack coupled to an upper side of the third sliding bracket to parallel the sliding guiding part, and engaged with the second relative moving pinion to relatively move the third sliding bracket with respect to the second sliding bracket.

16. The transferring system according to claim 14, wherein the second relative moving member comprises:
a third relative moving rack coupled to a lower side of the second sliding bracket to parallel the sliding guiding part;
a second relative moving shaft rotatably coupled to the third sliding bracket;
a third relative moving pinion provided to a first side of the second relative moving shaft to be rotatably engaged with the third relative moving rack according to the relative moving of the third sliding bracket;
a fourth relative moving pinion provided to a second side of the second relative moving shaft to rotate according to rotating of the third relative moving pinion; and
a fourth relative moving rack coupled to an upper side of the fourth sliding bracket and disposed parallel to the sliding guiding part, and engaged with the fourth relative moving pinion to relatively move the fourth sliding bracket with respect to the third sliding bracket.

17. The transferring system according to claim 11, wherein the moving supporting part comprises a roller coupled to the sliding unit main body to movably support the sliding brackets.

18. The transferring system according to claim 1, wherein the buffering apparatus comprises:
a workpiece supporting plate to support the workpiece;
a plurality of buffer supporting members to extend in an up and/or down direction of the hoist unit, and supported to an installation surface to be coupled to the workpiece supporting plate; and
a planar buffer supporting bracket coupled to the buffer supporting members to be coupled to the supporting part.

19. The transferring system according to claim 18, wherein the supporting part comprises a roller to movably support the sliding brackets.

20. The transferring system according to claim 1, wherein the buffering apparatus is disposed in opposite sides with respect to the traveling direction of the transferring apparatus to be distanced from the transferring apparatus.

21. A transferring system to transfer a workpiece, the transferring system comprising:
a transferring apparatus having a main body unit to travel along a traveling path of a rail, a sliding unit coupled to the main body and having first and second brackets, a sliding driving part to move the first bracket by a first distance with respect to the main body unit, and a relative moving part to move the second bracket with respect to the first bracket by a second distance according to a movement of the first bracket, and a hoist unit coupled to the second bracket to carry a workpiece.

22. The transferring system according to claim 21, further comprising:
a buffering apparatus disposed adjacent to the transferring apparatus, and having a first supporting part to support the first bracket and a second supporting part to support the second bracket when the first bracket and the second bracket move.

23. The transferring system according to claim 22, wherein the first supporting part is disposed to support a first length of the first bracket, and the second supporting part is disposed to support a second length of the second bracket.

24. The transferring system according to claim 22, wherein the second bracket and the hoist moves a third distance with respect to the main body unit.

25. The transferring system according to claim 21, wherein:
the sliding unit further comprises another bracket disposed between the first and second brackets and another relative moving part to move the third bracket with respect to the first bracket by a another distance according to a movement of the first bracket; and
the relative moving part to move the second bracket with respect to the another bracket by a third distance.

26. The transferring system according to claim 21, wherein the sliding unit further comprises a sliding guiding part to guide the first and second brackets to move with respect to each other and the main body unit.

27. The transferring system according to claim 21, wherein the first bracket and the second bracket have a first length and a second length, respectively, in a direction perpendicular to the traveling path.
